(19) United States
(12) Patent Application Publication
(10) Pub. No.: US 2017/0053175 A1
(43) Pub. Date: Feb. 23, 2017

(54) SYSTEM AND METHOD FOR VALIDATING THREE-DIMENSIONAL OBJECTS

(71) Applicant: FaceTec, Inc., Las Vegas, NV (US)

(72) Inventor: Kevin Alan Tussy, Las Vegas, NV (US)

(21) Appl. No.: 15/239,682

(22) Filed: Aug. 17, 2016

Related U.S. Application Data
(60) Provisional application No. 62/206,151, filed on Aug. 17, 2015.

(51) Int. Cl. G06K 9/00

(52) U.S. Cl. CPC G06K 9/00906; G06K 9/00288; G06K 9/00255

(57) ABSTRACT

A system for verifying the presence of a three-dimensional object. The system has a plurality of two-dimensional cameras. Each camera is oriented to face a different direction. Cameras adjacent to each other are set to have overlapping field of a views. An image processor conducts image recognition on images received from the cameras. The three dimensions of the object are verified by comparing the image recognition in the overlapping field of views.

### CROSS REFERENCE TO RELATED APPLICATION

This application claims priority to U.S. Provisional Application No. 62/206,151 which was filed on Aug. 17, 2015, the contents of which are hereby incorporated by reference.

### BACKGROUND

1. Field

The disclosed embodiments relate to still and video photography. Specifically, the disclosed embodiments relate to systems and methods to validate the existence of the three-dimensional objects.

2. Related Art

Still and video photography are prevalent throughout society. Almost everyone has access to a camera with which to record still and video images. People enjoy using cameras to preserve memories of important events, vacations, and even the food they eat. Cameras are also utilized in other applications for entertainment, research, and security.

For example, a camera may be utilized to provide controlled access to a building or room, or may aid in controlling access to an electronic device, a network, or a particular software program. This may be done by using a camera to image a person's face, and then using a computer with facial recognition software to process the image to determine whether the imaged face matches stored credentials.

A major drawback, however, in using facial recognition for security or other similar applications is that the facial recognition system may be circumvented. For example, a picture of an authorized person may be placed in front of the camera in order to spoof the facial recognition system. One reason that typical systems may be spoofed in this manner is because the camera being used is a two-dimensional camera. With a two-dimensional camera, the image produced by the camera is similar regardless of whether the camera images the actual person or a picture of the person.

One method to determine whether the actual, three-dimensional person is being imaged is through use of a three-dimensional camera. A typical three-dimensional camera utilizes two lenses and two sensors. The lenses are placed slightly apart while imaging to capture an image at a slightly different perspective. This simulates how the human eyes see and interpret objects in three-dimensional space. By using a three-dimensional camera, the system can determine whether an actual, three-dimensional person is being imaged, or whether a mere picture of the person is being imaged. This is because the three-dimensional camera can determine the depth of field in the resulting three-dimensional image.

In spite of this, three-dimensional cameras are not widely used for security purposes to validate the presence of an actual, three-dimensional person. Three-dimensional cameras are currently specialty cameras that require additional, specialized hardware and programming as compared with conventional, two-dimensional cameras. Further, demand for three-dimensional cameras has been limited. Thus, for practical matters, three-dimensional cameras for security have not been implemented.

### SUMMARY

Accordingly, there is a need for a system that can validate the presence of a three-dimensional person or other object without incorporating a specialized, three-dimensional camera. The disclosed embodiments have been developed in light of this and aspects of the invention may include a system for verifying the presence of a three-dimensional object. The system has a plurality of two-dimensional cameras. Each camera is oriented to face a different direction. Cameras adjacent to each other are set to have overlapping field of a views. An image processor conducts image recognition on images received from the cameras. The three dimensions of the object are verified by comparing the image recognition of the object in the overlapping field of views.

In some embodiments, the system may include facial recognition as the image recognition. The facial recognition generates biometric measurements between facial features detected in the images received from cameras, and the biometric measurements generated from the images received from the cameras are compared to expected differences. When the biometric measurements meet the expected differences within a predetermined threshold, a person being imaged is authenticated as a real person.

In some instances, the adjacent cameras are angled away from one another. In others, the adjacent cameras are angled towards one another.

In other embodiments, there is a system provided for verifying the presence of a three-dimensional object. The system may comprise a plurality of two-dimensional cameras disposed such that fields of the plurality of two-dimensional cameras overlap. Adjacent cameras may be angled away from one another.

There may also be an image processor communicatively coupled to the cameras. The image processor receives image data from each of the plurality of two-dimensional cameras and analyzes the image data to identify a person within an area of the overlapping fields of at least two of the two-dimensional cameras. The image processor further conducts facial recognition on a face of the person from the image data from the two cameras and compares results from the facial recognition for the image data from the two cameras. The person is validated as a real, three-dimensional person when the results from the facial recognition for the image data from the two cameras varies by a predetermined amount.

In some instances a number of the two-dimensional cameras being used is three. On example of results from the facial recognition for the image data from the two cameras is distances between facial features. In this example, the person is validated as a real, three-dimensional person when the distances between facial features are different in the image data from the two cameras. Another example of results from the facial recognition for the image data from the two cameras is the prominence of one or more facial features. In this example, the person is validated as a real, three-dimensional person when the prominences of the one or more facial features is different in the image data from the two cameras.

In another embodiment, a method for validating the presence of a three-dimensional object is provided. The method may comprise orienting at least two cameras at an angle to one another such that the at least two cameras maintain an overlapping field of view, and detecting a first feature in the overlapping field of view of the at least two cameras. Next, image feature recognition may be conducted on the detected feature from image data received from a first camera of the at least two cameras and a second camera from the at least two cameras. First results of the image feature recognition from the image data from the first camera is compared to second results of the image feature recognition from the image data from the second camera. The detected first feature is validated as a three-dimensional feature when the first results differ from the second results within a predetermined amount.

In some instances, a first feature may be a person, and the image feature recognition may be facial recognition of a face of the person. The first and second results may include distances between facial features on the face of the person. In this example, the person would be validated as three-dimensional when distances between facial features in the first results and the second results differ within the predetermined amount.

In another embodiment, the first and second results include prominence of facial features on the face of the person. In this example, the person would be validated as three-dimensional when the prominence of the facial features in the first results and the second results differ within the predetermine amount.

The at least two cameras may be oriented facing away from one another. Alternatively, the at least two cameras may be oriented facing towards one another.

The detecting, conducting, comparing, and validating steps may be performed by an image processor receiving image data from each of the at least two cameras. The image processor may be disposed remotely from the at least two cameras and is connected to the at least two cameras by a network.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

FIG. 1 shows a system for validating the presence of three-dimensional objects, according to one embodiment.

FIG. 2 shows a method for validating the presence of three-dimensional objects, according to one embodiment.

FIG. 3 is a schematic of a computing or mobile device such as one of the devices described above, according to one exemplary embodiment.

The components in the figures are not necessarily to scale, emphasis instead being placed upon illustrating the principles of the invention. In the figures, like reference numerals designate corresponding parts throughout the different views.

### DETAILED DESCRIPTION OF EMBODIMENTS

The following description outlines systems and methods for validating the presence of a three-dimensional object. The system and method is performed without the need for expensive three-dimensional camera equipment. The system and method is also performed without the need to create a three-dimensional image. The system and method may preferably be implemented with simple, readily available, two-dimensional cameras. The description below is provided to enable a person of ordinary skill to make and use the disclosed system and method. In some instances, a detailed description of features readily understood by the person of ordinary skill is omitted, in order not to obscure the invention.

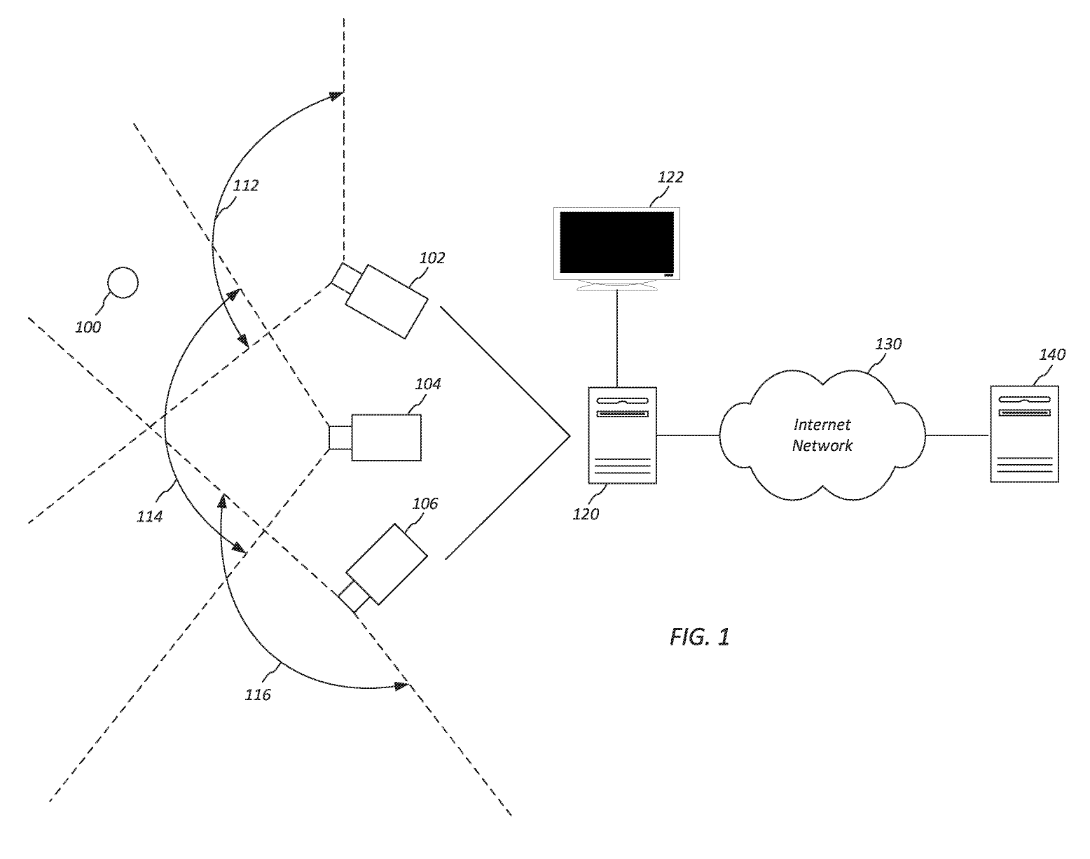

FIG. 1 shows a system for validating the presence of three-dimensional objects, according to one embodiment. The system incorporates at least two cameras that are oriented in different directions from one another. For example, in FIG. 1, the system incorporates three cameras 102, 104, 106. The cameras may be typical, inexpensive web cameras (“webcams”).

Cameras such as webcams typically include a lens, an image sensor, supporting electronics, and may also include a microphone for sound. Various lenses are available, the most common in consumer-grade webcams being a plastic lens that can be screwed in and out to focus the camera. Fixed focus lenses, which have no provision for adjustment, are also available. As a camera system's depth of field is greater for small image formats and is greater for lenses with a large f-number (small aperture), the systems used in webcams typically have a sufficiently large depth of field such that the use of a fixed focus lens does not impact image sharpness to a great extent.

Other lenses may also be used in the cameras 102, 104, 106. For example, the camera may incorporate an auto-focus lens, enabling a smaller depth of a field and a larger aperture, increasing image quality in certain instances. To increase the field of view of the cameras 102, 104, 106, a “fish-eye” lens may be used. Such a lens may have a field of view of as much as 180 degrees or greater.

The cameras 102, 104, 106 also each include image sensors. The image sensors can be, for example, CMOS or CCD, the former being typical for low-cost cameras such a webcams. Typical consumer webcams are capable of providing VGA resolution video at a frame rate of 30 frames per second. Other devices may also be used that produce video in multi-megapixel and at frame rates greater or less than 30 frames per second.

The cameras 102, 104, 106 also include support electronics that read the image from the sensor and transmit it to one or more host computers 120. Typically, each frame is transmitted uncompressed in an RGB or YUV format or compressed as a JPEG. The cameras 102, 104, 106 may use a CMOS sensor with supporting electronics “on die”, i.e. the sensor and the support electronics are built on a single silicon chip to save space and manufacturing costs. For further convenience, the cameras 102, 104, 106 may be compliant USB video device class (UVC) cameras that allow for interconnectivity of webcams to computers without the need for proprietary device drivers.

The host computer 120 receives the image transmitted from the cameras 102, 104, 106. The host computer 120 includes a central processing unit (CPU) for processing machine readable instructions or software. The computer 120 also includes one or more memories such as RAM, ROM and may also include one or more data storage devices such as solid state drives, hard disk drives, and other removable storage.

The host computer 120 may include program instructions or software to process the images received from the cameras 102, 104, 106. The instructions may be stored on one or more of the memories or storage devices of the computer 120. The host computer 120 may include a number of peripheral devices including a display monitor 122, a keyboard, mouse, and the like.

In some embodiments, the host computer 120 may be connected to a network 130, such as the Internet. Via the network 130, the host computer may communicate with a remote computer 140. The host computer 120 may receive machine readable instructions, or software, from the remote computer 140 in order to process the images. In other embodiments, the images taken by the cameras 102, 104, 106, or data obtained from the images, may be sent to the remote computer 140 via the network 130 for processing.

As shown in FIG. 1, the cameras 102, 104, 106 are disposed such that each camera is oriented to point in a different direction. Each camera 102, 104, 106 has a field of view 112, 114, 116 that is visible in the images obtained by the cameras 102, 104, 106. The orientation of the cameras 102, 104, 106 is such that the field of view of at least adjacent cameras overlap. In the embodiment shown in FIG. 1, the field of view 112 of camera 102 is set to overlap with the field of view 114 of camera 104. Similarly, the field of view 114 of camera 104 is set to overlap with the field of view 116 of camera 106. Preferably, as shown in FIG. 1, the field of view 112, 114, 116 of all of the cameras 102, 104, 106 overlap to some extent.

The difference in the orientation angle between the cameras may be as little as 2 degrees or as much as 90 degrees or more. Of course, where the cameras are oriented at 90 degrees or more relative to one another, the field of view of the camera must be very wide, such as one provided by a fish eye lens. Further, it is also possible that the field of view of all of the cameras (when more than two cameras are used) are set to overlap. In another embodiment, instead of the cameras 102, 104, 106 being oriented at different angels away from one another as shown in FIG. 1, the cameras 102, 104, 106 may be oriented so that the outside cameras 102, 106 are oriented towards the middle camera 104.

In the system shown in FIG. 1, the cameras 102, 104, 106 may periodically or continuously provide still or video images to the host computer 120. When an object 100 moves in front of one or more of the cameras 102, 104, 106, the object 100 is visible to multiple cameras in at least some positions. This is due to the field of views 112, 114, 116 of the cameras 102, 104, 106 overlapping. For example in FIG. 1, the object 100 is shown in a position where it is within the field of views 112, 114 of the cameras 102, 104.

When the object 100 moves through the fields of view 112, 114, 116 of the cameras 102, 104, 106, the system may detect the object 100 and perform image recognition on the object 100 to determine the identity of the object 100 and whether or not the object 100 is three-dimensional. For example, where the object 100 is a person, the system may detect the face of the person and perform image recognition to identify the person and determine whether the cameras 102, 104, 106 are imaging an actual, three-dimensional person. The manner in which this is determined is explained below.

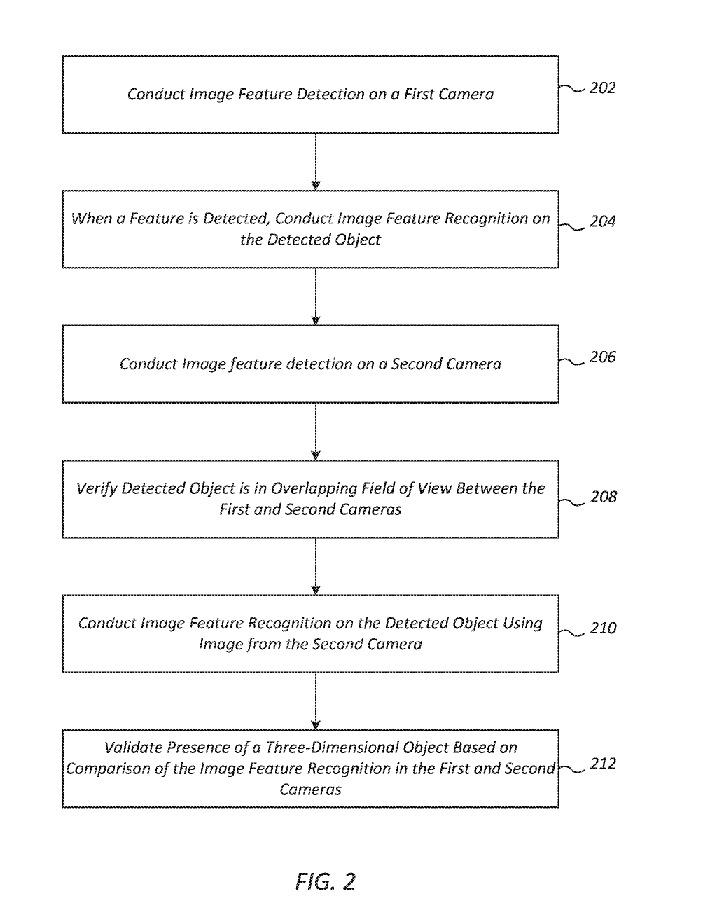

FIG. 2 shows a method for validating the presence of three-dimensional objects, according to one embodiment. As shown in FIG. 2, the system first conducts image feature detection on at least a first camera, as stated in step 202. For example, at least one of the cameras 102, 104, 106 may be periodically or continuously sending still or video images to the host computer 120. The host computer 120 or another remote computer 140 via the network 130 may conduct image feature detection on the images obtained by the cameras 102, 104, 106.

The image feature detection conducted by the system may be facial detection. That is, the system may analyze the images obtained by the cameras 102, 104, 106 to determine whether a face of a person is displayed in any of the images. The system may use any number of currently known or later developed image feature detection algorithms, such as face detection algorithms, to perform the image feature detection.

Once a particular feature in the image has been detected, the system may conduct image recognition on the detected object, as explained in step 204. Image recognition refers to analyses conducted on one or more image features to identify the detected feature in the image. For example, a facial recognition algorithm may identify a person by matching biometric information obtained from the image to known biometric information stored on a database. Examples of biometric information used in a facial recognition algorithm may include relative distances between facial features, skin and hair tones, orientation and relative size of facial features, and the like. However, the system may incorporate any currently known or later developed image recognition algorithm.

When an image feature is detected in images from one of the cameras, 102, 104, 106, the system then continues to conduct image feature detection on the other camera(s) in step 206. Preferably, the system looks to detect the image feature detected in the first camera in an image from an adjacent camera. In step 208, the system verifies that the image feature is detected simultaneously by two or more cameras. For example as shown in FIG. 1, the system may detect the object 100 in images from the cameras 102, 104 simultaneously when the object is in both the field of views 112, 114.

In step 210, the system conducts the image feature recognition in the second camera in addition to the image feature recognition in the first camera. That is, the system attempts to identify the image feature from an image taken at a different orientation. Once the system has conducted the image recognition analysis on the image feature from images received from at least two cameras, the system proceeds to step 212.

Here, the system validates the presence of a three-dimensional object based on a comparison of the image feature recognition of the images from the at least two cameras. The system may validate the three dimensions of the object in a number of ways. In the example of facial recognition, certain biometric measurements will change when a person's face is viewed at different orientation. For instance, in the two-dimensional images obtained by the cameras, a distance between the person's eyes, or between the eye and the ear will vary depending on whether the camera is imaging the person straight on or at a profile view. Further, different facial features will appear more or less prominent and at different orientations when imaged by the cameras.

The system thus validates the presence of an actual, three-dimensional person by comparing the facial recognition results in the images to confirm whether the expected differences in the results are obtained. Note that by performing this analysis, it is not necessary to generate a three dimensional image. Further, with the camera set at predetermined orientations from one another, the system can calculate an expected change in the comparison of biometric features as the person or object moves through the field of views from the camera. For example, when the object in in the field of view of all three cameras, the system can predict and validate the biometric readings of the person or other object in the three, two-dimensional images.

In this manner, the system may prevent a fraudster's attempt to spoof the system by using a picture of an authorized person for the cameras to image. If a two-dimensional picture is used, the system will determine that detected face is two-dimensional because the facial recognition from both orientations will either match (picture viewable in both images) or will not conform to expected results (picture viewable in one image, side of frame, paper, or screen viewable in the other).

Thus, by using two or more typical, inexpensive cameras, the system may determine whether or not an object imaged is three-dimensional. Importantly, the system can discern between an image of a two-dimensional object and a three-dimensional object without the need for a three-dimensional camera or without generating a three-dimensional image.

Other features and modifications may also be implemented on the system. For example, when the cameras 102, 104, 106 continuously provide images to the host computer, the object can be tracked as it moves through the field of view 112, 114, 116 of each of the cameras 102, 104, 106. In this manner, the image recognition, such as facial recognition, can be conducted and compared continuously. By comparing the continuous changes in the results of the image recognition comparison, the three dimensions of the object being imaged may further be verified.

By obtaining facial recognition from at least two different orientations, the system may also determine more information concerning the object. For example, in addition to facial recognition, the system may evaluate different features of the person to determine gender, an approximate age, and/or ethnicity of the person.

The system may be utilized as an authorization system. For example, the system may authorize the presence of an actual authorized person to control entry to a secured area or facility. The system may also secure access to information such as be granting access to a database based on authorizing approved personnel.

In the embodiments described above, the systems and methods require the use of various devices that each include computing devices. Examples of such devices may include various mobile devices such as a smartphone, tablet computing device, a laptop, etc. Other devices may include desktop computers, servers, or “wearable” technology such as smart watches, exercise activity monitors, or the like. Other “smart” devices including a variety of everyday objects which are reconfigured to incorporate a computing device and a transceiver for accessing a network may be utilized. These devices are often referred to as “Internet of Things” devices.

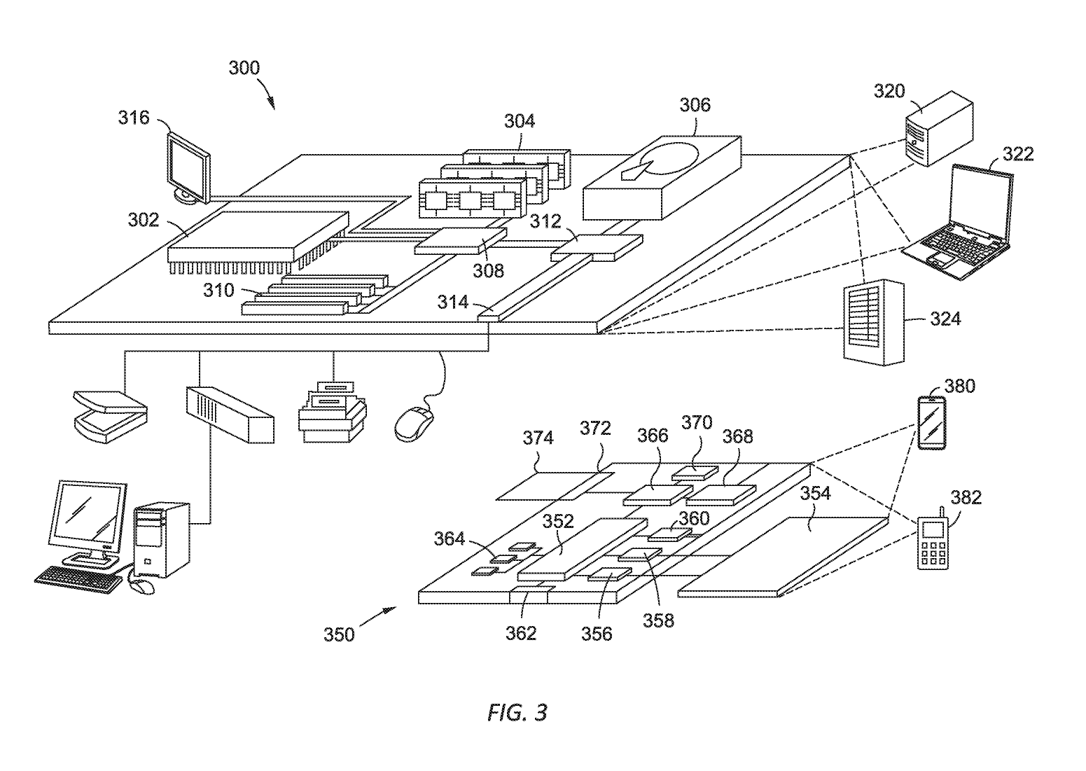

FIG. 3 is a schematic of a computing or mobile device such as one of the devices described above, according to one exemplary embodiment. FIG. 3 shows an example of a computing device 300 and a mobile computing device 350, which may be used with the techniques described here. Computing device 300 is intended to represent various forms of digital computers, such as laptops, desktops, workstations, personal digital assistants, servers, blade servers, mainframes, and other appropriate computers. Computing device 350 is intended to represent various forms of mobile devices, such as personal digital assistants, cellular telephones, smart phones, and other similar computing devices. The components shown here, their connections and relationships, and their functions, are meant to be exemplary only, and are not meant to limit the implementations described and/or claimed in this document.

Computing device 300 includes a processor 302, memory 304, a storage device 306, a high-speed interface or controller 308 connecting to memory 304 and high-speed expansion ports 310, and a low-speed interface or controller 312 connecting to low-speed bus 314 and storage device 306. Each of the components 302, 304, 306, 308, 310, and 312, are interconnected using various busses, and may be mounted on a common motherboard or in other manners as appropriate.

The processor 302 can process instructions for execution within the computing device 300, including instructions stored in the memory 304 or on the storage device 306 to display graphical information for a GUI on an external input/output device, such as display 116 coupled to high-speed controller 308. In other implementations, multiple processors and/or multiple buses may be used, as appropriate, along with multiple memories and types of memory. Also, multiple computing devices 300 may be connected, with each device providing portions of the necessary operations (e.g., as a server bank, a group of blade servers, or a multi-processor system).

The memory 304 stores information within the computing device 300. In one implementation, the memory 304 is a volatile memory unit or units. In another implementation, the memory 304 is a non-volatile memory unit or units. The memory 304 may also be another form of computer-readable medium, such as a magnetic or optical disk.

The storage device 306 is capable of providing mass storage for the computing device 300. In one implementation, the storage device 306 may be or contain a computer-readable medium, such as a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 304, the storage device 306, or memory on processor 302.

The high-speed controller 308 manages bandwidth-intensive operations for the computing device 300, while the low-speed controller 312 manages lower bandwidth-intensive operations. Such allocation of functions is exemplary only. In one implementation, the high-speed controller 308 is coupled to memory 304, display 116 (e.g., through a graphics processor or accelerator), and to high-speed expansion ports 310, which may accept various expansion cards (not shown). In the implementation, low-speed controller 312 is coupled to storage device 306 and low-speed bus 314. The low-speed bus 314, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 300 may be implemented in a number of different forms, as shown in the figure. For example, it may be implemented as a standard server 320, or multiple times in a group of such servers. It may also be implemented as part of a rack server system 324.

In addition, it may be implemented in a personal computer such as a laptop computer 322. Alternatively, components from computing device 300 may be combined with other components in a mobile device (not shown), such as device 350. Each of such devices may contain one or more of computing device 300, 350, and an entire system may be made up of multiple computing devices 300, 350 communicating with each other.

Computing device 350 includes a processor 352, memory 364, an input/output device such as a display 354, a communication interface 366, and a transceiver 368, among other components. The device 350 may also be provided with a storage device, such as a microdrive or other device, to provide additional storage. Each of the components 350, 352, 364, 354, 366, and 368, are interconnected using various buses, and several of the components may be mounted on a common motherboard or in other manners as appropriate.

The processor 352 can execute instructions within the computing device 350, including instructions stored in the memory 364. The processor may be implemented as a chipset of chips that include separate and multiple analog and digital processors. The processor may provide, for example, for coordination of the other components of the device 350, such as control of user interfaces, applications run by device 350, and wireless communication by device 350.

Processor 352 may communicate with a user through control interface 358 and display interface 356 coupled to a display 354. The display 354 may be, for example, a TFT LCD (Thin-Film-Transistor Liquid Crystal Display) or an OLED (Organic Light Emitting Diode) display, or other appropriate display technology. The display interface 356 may comprise appropriate circuitry for driving the display 354 to present graphical and other information to a user. The control interface 358 may receive commands from a user and convert them for submission to the processor 352. In addition, an external interface 362 may be provide in communication with processor 352, so as to enable near area communication of device 350 with other devices. External interface 362 may provide, for example, for wired communication in some implementations, or for wireless communication in other implementations, and multiple interfaces may also be used.

The memory 364 stores information within the computing device 350. The memory 364 can be implemented as one or more of a computer-readable medium or media, a volatile memory unit or units, or a non-volatile memory unit or units. Expansion memory 374 may also be provided and connected to device 350 through expansion interface 372, which may include, for example, a SIMM (Single In Line Memory Module) card interface. Such expansion memory 374 may provide extra storage space for device 350, or may also store applications or other information for device 350. Specifically, expansion memory 374 may include instructions to carry out or supplement the processes described above, and may include secure information also. Thus, for example, expansion memory 374 may be provide as a security module for device 350, and may be programmed with instructions that permit secure use of device 350. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 364, expansion memory 374, or memory on processor 352, that may be received, for example, over transceiver 368 or external interface 362.

Device 350 may communicate wirelessly through communication interface 366, which may include digital signal processing circuitry where necessary. Communication interface 366 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 368. In addition, short-range communication may occur, such as using a Bluetooth, Wifi, or other such transceiver (not shown). In addition, GPS (Global Positioning system) receiver module 370 may provide additional navigation- and location-related wireless data to device 350, which may be used as appropriate by applications running on device 350.

Device 350 may also communicate audibly using audio codec 360, which may receive spoken information from a user and convert it to usable digital information. Audio codec 360 may likewise generate audible sound for a user, such as through a speaker, e.g., in a handset of device 350. Such sound may include sound from voice telephone calls, may include recorded sound (e.g., voice messages, music files, etc.) and may also include sound generated by applications operating on device 350.

The computing device 350 may be implemented in a number of different forms, as shown in the figure. For example, it may be implemented as a cellular telephone 380. It may also be implemented as part of a smart phone 382, personal digital assistant, a computer tablet, or other similar mobile device.

Thus, various implementations of the systems and techniques described here can be realized in digital electronic circuitry, integrated circuitry, specially designed ASICs (application specific integrated circuits), computer hardware, firmware, software, and/or combinations thereof These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system (e.g., computing device 300 and/or 350) that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

While various embodiments of the invention have been described, it will be apparent to those of ordinary skill in the art that many more embodiments and implementations are possible that are within the scope of this invention. In addition, the various features, elements, and embodiments described herein may be claimed or combined in any combination or arrangement.

What is claimed is:

1. A system for verifying the presence of a three-dimensional object, the system comprising:
a plurality of two-dimensional cameras, each camera being oriented in a different direction and adjacent cameras having overlapping field of a views, and
an image processor conducting image recognition on images received from the cameras,
wherein
the three dimensions of the object are verified by comparing the image recognition in the overlapping field of views.

2. The system of claim 1, wherein the image recognition is facial recognition.

3. The system of claim 2, wherein the facial recognition generates biometric measurements between facial features detected in the images received from cameras, and the biometric measurements generated from the images received from the cameras are compared to expected differences.

4. The system of claim 3, further comprising an authentication processor wherein when the biometric measurements meet the expected differences within a predetermined threshold, a person being imaged is authenticated as a real person.

5. The system of claim 1, wherein the adjacent cameras are angled away from one another.

6. The system of claim 1, wherein the adjacent cameras are angled towards one another.

7. A system for verifying the presence of a three-dimensional object, the system comprising:
a plurality of two-dimensional cameras disposed such that fields of the plurality of two-dimensional cameras are overlapping, adjacent cameras of the plurality of two-dimensional cameras being angled away from one another; and
an image processor communicatively coupled to said plurality of two-dimensional cameras, the image processor receiving image data from each of the plurality of two-dimensional cameras and analyzing the image data to identify a person within an area of the overlapping fields of at least two of the plurality of two-dimensional cameras, conducting facial recognition on a face of the person from the image data from the at least two cameras, comparing results from the facial recognition for the image data from the at least two cameras, and validating that the person is a real, three-dimensional person when the results from the facial recognition for the image data from the at least two cameras varies by a predetermined amount.

8. The system of claim 7, wherein a number of the plurality of two-dimensional cameras is three.

9. The system of claim 7, wherein the results from the facial recognition for the image data from the at least two cameras comprises distances between facial features.

10. The system of claim 9, wherein the person is validated as a real, three-dimensional person when the distances between facial features are different in the image data from the at least two cameras.

11. The system of claim 7 wherein the results from the facial recognition for the image data from the at least two cameras comprises prominence of one or more facial features.

12. The system of claim 11, wherein the person is validated as a real, three-dimensional person when the prominences of the one or more facial features is different in the image data from the at least two cameras.

13. A method for validating the presence of a three-dimensional object, the method comprising:
orienting at least two cameras at an angle to one another such that the at least two cameras maintain an overlapping field of view;
detecting a first feature in the overlapping field of view of the at least two cameras;
conducting image feature recognition on the detected feature from image data received from a first camera of the at least two cameras and a second camera from the at least two cameras;
comparing first results of the image feature recognition from the image data from the first camera to second results of the image feature recognition from the image data from the second camera; and
validating that the detected first feature is a three-dimensional feature when the first results differ from the second results within a predetermined amount.

14. The method according to claim 13, wherein the first feature is a person, and the image feature recognition is facial recognition of a face of the person.

15. The method according to claim 14, wherein the first and second results include distances between facial features on the face of the person, and the person is validated as three-dimensional when distances between facial features in the first results and the second results differ within the predetermined amount.

16. The method according to claim 14, wherein the first and second results include prominence of facial features on the face of the person and the person is validated as three-dimensional when the prominence of the facial features in the first results and the second results differ within the predetermine amount.

17. The method according to claim 13, wherein the at least two cameras are oriented facing away from one another.

18. The method according to claim 13, wherein the at least two cameras are oriented facing towards one another.

19. The method according to claim 14, wherein the detecting, conducting, comparing, and validating steps are performed by an image processor receiving image data from each of the at least two cameras.

20. The method according to claim 19, wherein the image processor is disposed remotely from the at least two cameras and is connected to the at least two cameras by a network.
